(19) United States
(12) Patent Application Publication
(10) Pub. No.: US 2005/0155448 A1
(43) Pub. Date: Jul. 21, 2005

(54) Accelerator pedal module with friction hysteresis

(76) Inventors: Manfred Lochle, Stuttgart (DE); Dieter Papenhagen, Winnenden (DE)

Correspondence Address: KLAUS J. BACH, 4407 TWIN OAKS DRIVE, MURRYSVILLE, PA, 15668, US

(21) Appl. No.: 11/037,393

(22) Filed: Jan. 18, 2005

Related U.S. Application Data
(63) Continuation-in-part of application No. PCT/EP03/06986, filed on Jul. 1, 2002.

(30) Foreign Application Priority Data
Jul. 20, 2002 (DE) 103 33 038.7

(51) Int. Cl. G05G 1/14

(52) U.S. Cl. 74/513

(57) ABSTRACT

In an accelerator pedal module for a motor vehicle comprising an accelerator pedal for controlling an internal combustion engine and an accelerator pedal lever which is subjected to different frictional moments, depending on its pivot position so as to provide a hysteresis, a friction element 4 is provided which engages a friction body on the pivot shaft 2.1 of the pedal lever and is pivotally mounted on the pedal lever and connected to a support structure of the pedal module via a spring element so as to provide position-dependent frictional moments by the frictional engagement forces thereby generating a hysteresis.

This is a Continuation-In-Part Application of International Application PCT/EP03/006986 filed Jul. 01, 2003 and claiming the priority of German Application 102 33 038.7 filed Jul. 02, 2002.

### BACKGROUND OF THE INVENTION

The invention relates to an accelerator pedal module having a pedal lever mounted on a support structure such that it can be pivoted about a pivot shaft. The force which is needed to pivot or rotate the pedal lever changes with the position of the pedal lever. For this purpose, a friction element acts directly on the pedal lever or a frictional body arranged on the pedal lever. The friction element is connected to a spring element in such a way that the frictional force between the frictional body and the friction element varies in relation to the pivot position of the pedal lever, because of the lengthening of the spring element.

A pedal lever for actuating equipment in motor vehicles, such as a control element of an internal combustion engine, is already known. In this case, the force of the return spring for the pedal lever is used at the same time to generate the frictional moment required to build up a force-travel hysteresis, which generates moments which are different for the various movement directions of the pedal lever.

For this purpose, the pedal lever is mounted such that it can be pivoted on a bearing shaft, which is supported on a vehicle part. The pedal lever interacts with a frictional element, which generates a frictional moment during the movement of the pedal lever. A frictional body is pressed against a friction surface of a fixed supporting part under the action of the spring element. The frictional body is coupled to the return spring which provides the return force for the pedal lever.

It is the object of the invention to provide an accelerator pedal module in such a way that the movement-dependent frictional force of the friction element can be selected as a function of its position relative to the pedal lever, and the installation of the accelerator pedal module, together with the friction element, is facilitated.

### SUMMARY OF THE INVENTION

In an accelerator pedal module for a motor vehicle comprising an accelerator pedal for controlling an internal combustion engine and an accelerator pedal lever which is subjected to different frictional moments, depending on its pivot position so as to provide a hysteresis, a friction element 4 is provided which engages a friction body on the pivot shaft 2.1 of the pedal lever and is pivotally mounted on the pedal lever and connected to a support structure of the pedal module via a spring element so as to provide position-dependent frictional moments by the frictional engagement forces thereby generating a hysteresis.

The friction element can be mounted on the pedal lever at various points such that the pedal lever can be rotated with the frictional element about the bearing body. The pedal lever bearing and the matching bearing must be provided at different locations of the pedal lever. The different locations result in different distances between the matching bearing of the friction element and the point at which the friction element is in contact with the bearing body. These distances are critical for the transmitted frictional force or for the frictional moment produced. For mounting, the friction element is pushed onto the bearing on the pedal lever and placed on the frictional bearing body. The spring element is hooked into the engagement hook on the friction element. Disassembly is carried out in a correspondingly simple way for the removal of the accelerator pedal.

The friction element has a bearing, for example, in the form of a hole or pin. Such a bearing can be pushed on and, in principle, requires no maintenance. Because of the small amount of movement of the friction element, the bearing is virtually free of wear. The bearing of the friction element is pushed onto a correspondingly inversely shaped matching bearing pin on the pedal lever.

Preferably, the friction element has a hole, or a hook for engaging one end of the spring element. The spring element is connected to the holder by its second end. By means of the spring force, the friction element is pressed against the frictional surface of the friction body by the spring element which may be a compression spring or a tension spring.

The friction bearing body does not need to be cylindrical but could also be slightly conical. With a conical arrangement the friction element is moved in the axial direction against the pedal lever when the pedal lever is actuated.

It is also advantageous if the friction element completely or partially surrounds or encloses the frictional body of the pedal lever shaft. Preferably, the friction element is formed substantially as a ring, which is pushed onto the stationary frictional body.

The friction element may also have the shape of a sickle or semicircle whereby some weight could be saved.

Finally the frictional body may comprise a plurality of frictional surface areas arranged rotationally symmetrically around the frictional body.

The friction element pivot bearing and the matching bearing on the pedal lever may be arranged at different locations around the friction element. The distance, designated the frictional radius, between the bearing of the friction element and the mounting point of the spring element is thus variable. The frictional force resulting from the spring force is changed with the displacement of the bearing location that is with a change in the frictional radius.

In order to configure an accelerator pedal module of which the frictional radius can be adjusted, the friction element and the pedal lever each have a hole as the bearing or matching bearing. Bearing and matching bearing are joined such that the friction element can pivot by means of a further bearing element, for example, in the form of a pin which is inserted into the pedal lever hole and extends through the friction element hole. As a result of forming the bearing and the matching bearing as holes through which a pin extends, the frictional radius can be changed by inserting the pin through different holes in the friction element and the pedal lever.

Preferably, the pedal lever, the frictional body and the matching bearing structure are formed from identical materials. This has manufacturing advantages as some components can be produced in one operation without an additional joining process.

Preferably, at least two friction elements, one at each side of the pedal lever, are provided.

The friction element may be made by molding or die casting in one fabrication process.

The spring element may be pre-stressed so that a friction force is present already in the rest position of the pedal lever.

The invention will become more readily apparent from the following description of a preferred embodiment thereof with reference to the accompanying drawings.

### BRIEF DESCRIPTION OF THE DRAWINGS

FIG. 1 is a perspective view of the various components of an accelerator pedal module,

FIG. 2 is a side view of the accelerator pedal module,

FIG. 3 is a side view of the accelerator pedal bearing and of the matching bearing in a first position,

FIG. 4 is a side view of the bearing and of the matching bearing in a second position,

FIG. 5 is a side view of the bearing and of the matching bearing in a third position, and

FIG. 6 is a side view of the bearing and of the matching bearing in a fourth position.

### DESCRIPTION OF A PREFERRED EMBODIMENT

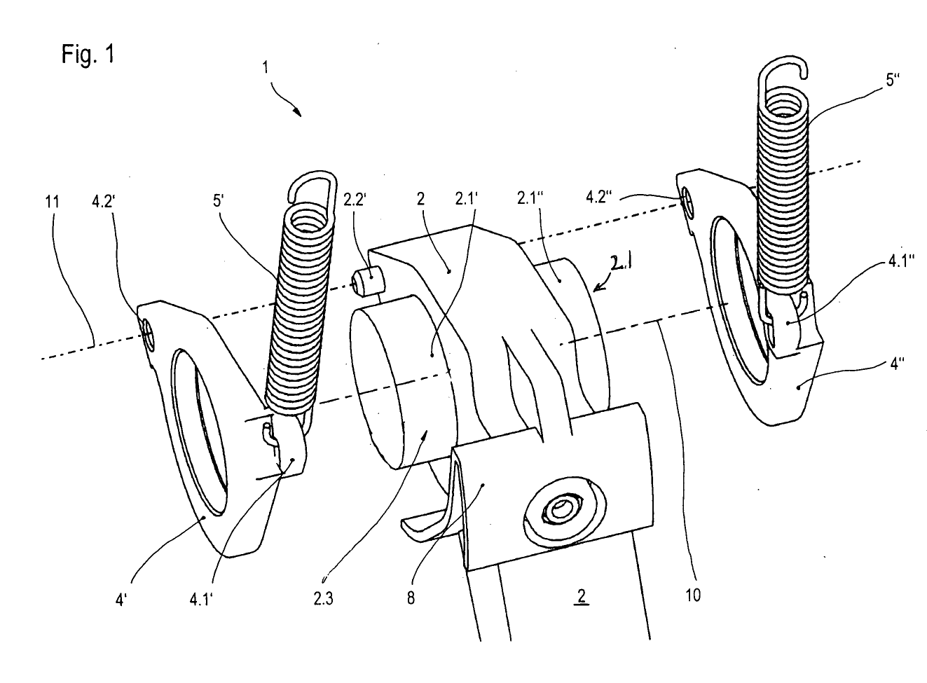

FIG. 1 shows, in a perspective view, the components of an accelerator pedal module 1. Identical parts have the same designations in all the figures. Identical or identically constructed parts which, according to FIG. 1, are provided on both sides of the accelerator pedal module 1, are distinguished by one or more apostrophes assigned to the designations.

FIG. 1 shows, as a central part, a pedal lever 2 supported on a bearing shaft which is provided on the left and right in the direction of a pivot axis 10 of the pedal lever 2, with frictional body 2.1′, 2.1″. The frictional bodies 2.1′, 2.1″ are cylindrical and are concentrically relative to the pedal power lever pivot axis 10.

Parallel to the pivot axis 10, there extends a bearing axis 11. Fitted concentrically with respect to the bearing axis 11, in the upper region on the pedal lever 2, at opposite sides of the lever 2 are matching bearing structures 2.2′ in the form of a pin. Only one matching bearing pin 2.2′ is illustrated in FIG. 1. The matching bearing pins 2.2′ are cylindrical. The end of the matching bearing pin 2.2′ is provided with a chamfer in the edge region to facilitate mounting of a friction element 4. Each of the two matching bearings pins 2.2′ is used for mounting a friction element 4′, 4″.

The friction elements 4′, 4″ are annular and have a circular hole with a diameter which, with an appropriate tolerance, corresponds to the diameter of the circular frictional bodies 2.1′, 2.1″. Depending on the configuration, these two diameters differ in the micrometer range or in the millimeter range up to five millimeters.

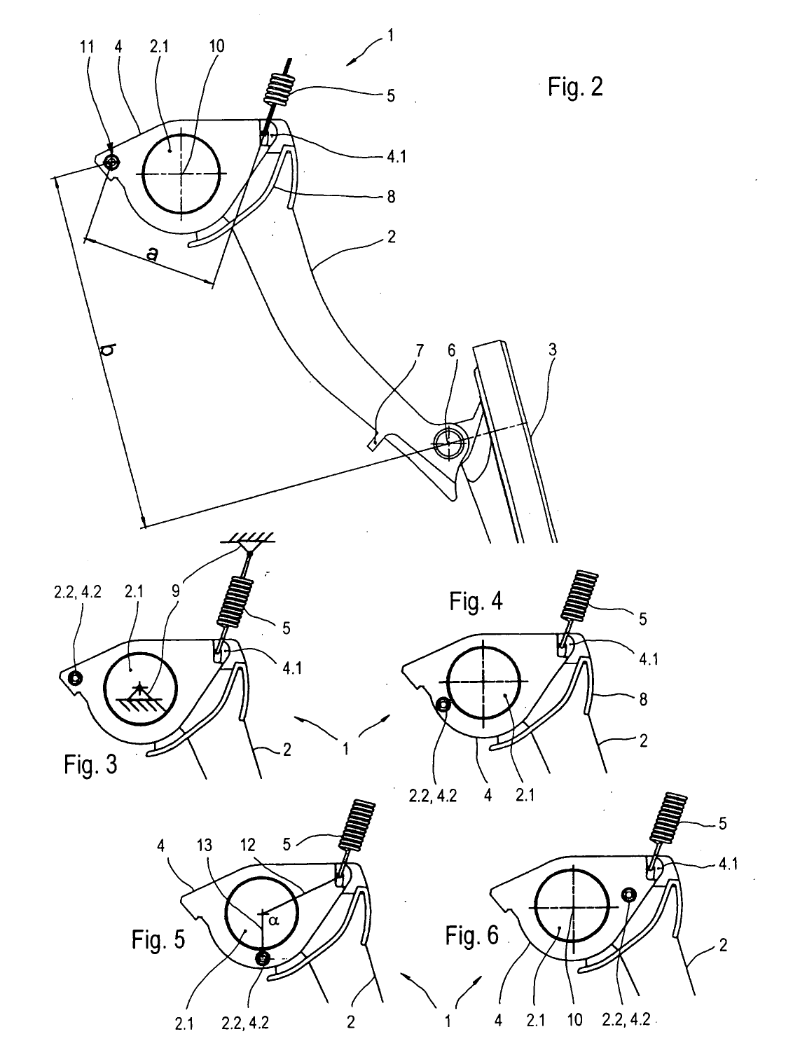

The friction element 4 has a frictional surface, which is brought at least partly into contact with a frictional surface 2.3 of the frictional body 2.1′. For this purpose, the friction element 4′, 4″ is mounted on the matching bearing 2.2′, 2.2″, such that it can rotate by means of a bearing structure 4.2′, 4.2″. In this position, as illustrated in FIG. 2, the friction element 4′, 4″ surrounds or encloses the frictional body 2.1′, 2.1″. The bearing 4.2′, 4.2″ as well as the matching bearing structure 2.2′, 2.2″ has a chamfer in the edge regions, in order to facilitate mounting.

Provided on the friction element 4′, 4″ is an engagement structure 4.1′, 4″ forming a hole or a slot, into which one end of a spring element 5′, 5″ is hooked. The spring element 5′, 5″ is a spiral spring with hooks formed at the opposite ends. The other end of the spring element 5′ 5″ is connected to a support structure 9, which, in FIG. 3, is illustrated in the form of a bearing symbol. In addition, the pedal lever 2 is mounted on the support structure 9 via a shaft 2.1, which is, at its axial ends forms the frictional bodies 2.1′, 2.1″, as likewise illustrated symbolically in FIGS. 1 and 3.

In FIG. 1 only the upper part of the pedal lever 2 is illustrated. The upper part shown of the pedal lever 2 has a protective front plate 8 in the transition region from the frictional bodies 2.1′, 2,1″ downward to the actual pedal lever 2. The protective front plate 8 prevents deposition of dirt. The pedal lever 2, the bearing shaft 2.1 and matching bearing pin 2.2′ consist of the same material.

FIG. 2 is a side view of an accelerator pedal module showing the pedal lever 2, an accelerator pedal bearing 6 and an accelerator pedal 3, which is illustrated only partly. On the rear side of the pedal lever 2, opposite the accelerator pedal bearing 6, a stop 7 is provided which strikes an opposing stop, not illustrated, when the accelerator pedal 3 is fully pressed down.

In FIG. 2, the parallel arrangement of the pivot lever axis 10 and of the bearing axis 11 is illustrated. The pivot axis 10 extends through the center of the shaft 2.1, and the bearing axis 11 extends through the centers of bearing structure 4.2 and matching bearings structure 2.2′.

The distance of the center of the bearing 4.2 and of the matching bearing structure 2.2 from the force line of the spring 5 is designated the frictional radius a. A distance which is also important for the adjustment of the hysteresis is the distance between the line of the force acting on the accelerator pedal 3 in order to actuate the accelerator pedal 3 from the bearing axis 11. This distance between the force line of the actuating force on the pedal 3 and the matching bearing 2.2 is designated the pedal action radius b.

The ratio of frictional radius b and the frictional radius a defines the frictional relationships between the frictional body 2.1 and on the forces effective on the pedal 3.

FIG. 3 is a side view showing the bearing structure 4.2 and the matching bearing structure 2.2 in a first position of those bearing structures. As illustrated in the further FIGS. 4 to 6, the location of the bearing structures 4.2 and 2.2′ can be changed. As a result, the frictional relationships and the regions of the frictional surface engagement between the friction element 4 and the frictional body 2.1 can be changed. According to FIG. 3, the friction element 4 is in frictional contact with the frictional body 2.1 substantially in the lower region of the frictional surfaces. In a corresponding way, other regions are in frictional contact. For example, according to FIG. 6, the upper regions of the frictional surfaces of friction element 4 and frictional body 2.1 abut each other.

FIG. 4 is a side view of the bearing structure 4.2 and of the matching bearing structure 2.2 in a second location. Friction element 4 and frictional body 2.2 also engage the friction body substantially in its lower region. The position of the bearing arrangement of bearing 4.2 and matching bearing 2.2 greatly affect the generation of the hysteresis. The hysteresis can be configured as desired as a function of the frictional values and the spring constant of the spring element 5 by displacing the bearing structure. On the right beside the friction element 4, the protective front plate 8 is shown on the pedal lever 2.

FIG. 5 is a side view with the bearing structure 4.2 and of the matching bearing structure 2.2 in a third location. Also, illustrated in FIG. 5 are a first connecting line 12 and a second connecting line 13. These are used to describe the flexible location of the bearing arrangement of bearing structure 4.2 and matching bearing structure 2.2 by indicating the angle α formed by these two connecting lines. A plurality of bearing structures 4.2 and matching bearing structures 2.2 may be provided on an accelerator pedal module 1.

FIG. 6 is a side view of the bearing structures 4.2 and of the matching bearing structure 2.2 in a fourth position. In the arrangement, only the upper region of the friction element 4 is in engagement with the friction member 2.1.

1. An accelerator pedal module (1) having a pedal lever (2) mounted in a support structure including a shaft (2.1) such that it can be pivoted about the shaft (2.1), said shaft (2.1) having friction end sections extending axially at opposite sides of the pedal lever (2) and forming friction bodies (2.1′, 2.1″), a friction element (4) pivotally supported on the pedal lever (2), a spring element (5) connected to the friction element (4) arranged on the pedal lever (2) such that the frictional engagement force between the frictional body (2.1′,2.1″) and the friction element (4) varies relative to the pivot position of the pedal lever (2), the friction element (4) being a rigid body, which is mounted such that it can pivot on the pedal lever (2), and the spring element (5) being connected to the support structure (9) for biasing the friction element (4) into engagement with the frictional body (2.1′, 2.1″).

2. An accelerator pedal module according to claim 1, wherein the friction element (4) has a bearing (4.2), by way of which it is pivotably mounted on the pedal lever (2) in a matching bearing (2.2).

3. An accelerator pedal module according to claim 1, wherein the friction element (4) has retaining structure (4.1), and the friction element (4) is connected to the support structure (9) via a spring element (5) hooked into the retaining structure (4.1).

4. An accelerator pedal module according to claim 1, wherein the frictional body (2.1) has a frictional surface and the frictional element (4) has an opening receiving the friction body (2.1) with the frictional surface surrounding the frictional body (2.1).

5. An accelerator pedal module according to claim 1, wherein the frictional element (4) has a plurality of bearing structures (4.2) and the pedal lever (2) has a plurality of matching bearing structures (2.2) permitting a change of the location of the pivot bearing for the friction element (4).

6. An accelerator pedal module according to claim 1, wherein the pedal lever (2) has a first pivot axis (10), and the friction element (4) has a bearing axis (11) parallel to, but spaced from, the pivot axis (10).

7. An accelerator pedal module according to claim 1, wherein the pivot lever (2), the frictional body (2.1′, 2.1″) and the matching bearing structure (2.2) consist all of the same material.

8. An accelerator pedal module according to claim 1, wherein at least two friction elements (4) are provided, one at each side of the pedal lever (2) and the friction elements (4) are each in contact with a frictional body (2.1′, 2.1″) at one side and, respectfully, the opposite side of the pedal lever (2).

9. An accelerator pedal module according to claim 1, wherein the friction element (4) is a molding or die casting.
